(19) United States
(12) Patent Application Publication
(10) Pub. No.: US 2016/0066382 A1
(43) Pub. Date: Mar. 3, 2016

(54) LIGHT EMITTING APPARATUS COMPRISING INDIVIDUALLY CONTROLLED LIGHT EMITTING CIRCUITS ON AN INTEGRATED CIRCUIT

(71) Applicant: Bridgelux, Inc., Livermore, CA (US)

(72) Inventor: Vladimir ODNOBLYUDOV, Danville, CA (US)

(21) Appl. No.: 14/470,890

(22) Filed: Aug. 27, 2014

(51) Int. Cl. H05B 33/08

(52) U.S. Cl. CPC H05B 33/0845

(57) ABSTRACT

Various aspects of a light emitting apparatus include an integrated circuit having several electrically coupled light emitting circuits. The integrated circuit includes several control lines to control the light emitting circuits. Each of the control lines is configured to provide individual control for a different one of the light emitting circuits from a source remote to the integrated circuit.

### BACKGROUND

1. Field

The present disclosure relates generally to a light emitting apparatus, and more particularly, to a light emitting apparatus having several individually controlled light emitting circuits comprised on an integrated circuit.

2. Background

Solid state light emitting circuits, such as light emitting dies (LEDs), are attractive candidates for replacing conventional light sources such as incandescent, halogen, and fluorescent lamps. LEDs have substantially longer lifetimes than all three of these types of conventional light sources. In addition, some types of LEDs now have higher conversion efficiencies than fluorescent light sources and still higher conversion efficiencies have been demonstrated in laboratories. Finally, LEDs contain no mercury or other potentially dangerous materials, therefore, providing various safety and environmental benefits.

Variable intensity LEDs have been increasingly used in various lighting applications. Using such LEDs generally requires wiring each of the LEDs together to form a large circuit of LEDs. However, larger designs are undesirable because they can be difficult to fit in different light housings and inefficient. Therefore, it would be desirable to integrate a plurality of variable intensity LEDs on a single integrated circuit.

### SUMMARY

Several aspects of the present invention will be described more fully hereinafter with reference to various apparatuses.

Some aspects of a light emitting apparatus include an integrated circuit having several electrically coupled light emitting circuits. The integrated circuit includes several control lines to control the light emitting circuits. Each of the control lines is configured to provide individual control for a different one of the light emitting circuits from a source remote to the integrated circuit.

Other aspects of the light emitting apparatus include an integrated circuit having several electrically coupled light emitting circuits. Each of the light emitting circuits has an output. The integrated circuit has several control lines. Each of the control lines provides a connection from a remote source to the output of a different one of the light emitting circuits.

Other aspects of the light emitting apparatus include an integrated circuit. The integrated circuit includes several series coupled light emitting circuits. The series coupling of light emitting circuits includes an input. Each of the light emitting circuits includes an output. The integrated circuit includes several control lines. Each of the control lines includes a connection from a remote source to a different one of the light emitting circuits. The light emitting apparatus includes a controller configured to control the intensity of light emitted from the integrated circuit by selectively coupling a power source between the input of the series coupled light emitting circuits and one of the outputs of the light emitting circuits.

It is understood that other aspects of methods and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses will now be presented in the detailed description by way of example, and not by way of limitation, with reference to the accompanying drawings, wherein:

FIG. 1 illustrates an exemplary embodiment of an LED.

FIG. 2 illustrates a cross section view of a light emitting circuit.

FIG. 3 illustrates an exemplary embodiment of a top view of a light emitting circuit.

FIG. 4 illustrates an exemplary embodiment of a schematic view of an integrated circuit having several light emitting circuits.

FIG. 5 illustrates an exemplary embodiment of a schematic view of an integrated circuit coupled to a controller.

FIG. 6 illustrates an exemplary embodiment of a top view of an integrated circuit coupled to the controller.

FIGS. 7a-7c are side view illustrations of various exemplary apparatuses having a light-emitting circuit.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The various aspects of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus or method.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

The word “exemplary” is used herein to mean serving as an example, instance, or illustration. Any embodiment described herein as “exemplary” is not necessarily to be construed as preferred or advantageous over other embodiments. Likewise, the term “embodiment” or “aspect” of an apparatus, method or article of manufacture does not require that all embodiments of the invention include the described components, structure, features, functionality, processes, advantages, benefits, or modes of operation.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element.

Furthermore, relative terms, such as “beneath” or “bottom” and “above” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being “above” other elements would then be oriented “below” other elements and vice versa. The term “above”, can therefore, encompass both an orientation of “above” and “below,” depending of the particular orientation of the apparatus. Similarly, if an apparatus in the drawing is turned over, elements described as “below” other elements would then be oriented “above” the other elements. The terms “below” can, therefore, encompass both an orientation of above and below.

It will be further understood that the terms “comprises” and/or “comprising,” when used in this specification, specify the presence of stated features, steps, operations, elements, and/or components, but do not preclude the presence or addition of one or more other features, integers, steps, operations, elements, components, and/or groups thereof. The term “and/or” includes any and all combinations of one or more of the associated listed items.

Additionally, the term “coupled” or “electrically coupled” as used herein can indicate that an electrical component is coupled to another component by way of electrical traces or wire bonding. The component may be directly coupled, with no intervening elements, to another component, or indirectly coupled, where intervening components are between the coupled components. The components are electrically coupled when a current may flow from a first coupled component to a second. By way of example, a light emitting circuit may be electrically coupled to another light emitting circuit by an electrical trace. However, other intervening circuits may be between such electrically coupled circuits.

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the following detailed description, various aspects of the present invention will be presented in the context of an integrated circuit comprising a plurality of solid state light emitters. A solid state light emitter shall be construed broadly to include any suitable solid state light source such as, by way of example, a light emitting diode (LED) or other semiconductor material which releases photons or light through the recombination of electrons and holes flowing across a p-n junction. Accordingly, any reference to an LED or other solid state light source throughout this disclosure is intended only to illustrate the various aspects of the present invention, with the understanding that such aspects may have a wide range of applications.

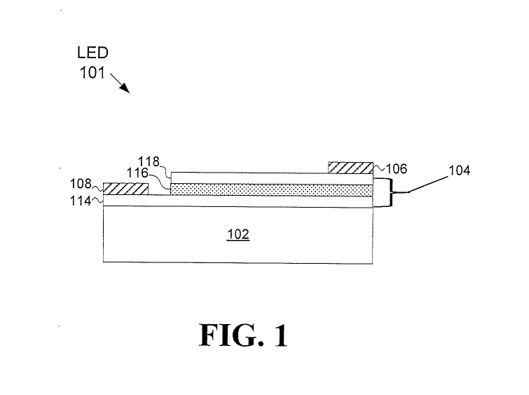

FIG. 1 illustrates an exemplary embodiment of an LED 101. An LED is a semiconductor material impregnated, or doped, with impurities. These impurities add “electrons” or “holes” to the semiconductor, which can move in the material relatively freely. Depending on the kind of impurity, a doped region of the semiconductor can have predominantly electrons or holes, and is referred respectively as n-type or p-type semiconductor regions.

Referring to FIG. 1, the LED 101 includes an n-type semiconductor region 114 and a p-type semiconductor region 118. A reverse electric field is created at the junction between the two regions, which causes the electrons and holes to move away from the junction to form an active region 116. When a forward voltage sufficient to overcome the reverse electric field is applied across the p-n junction through a pair of electrodes 108, 106, electrons and holes are forced into the active region 116 and recombine. When electrons recombine with holes, they fall to lower energy levels and release energy in the form of light.

In this example, the n-type semiconductor region 114 is formed on a substrate 102 and the p-type semiconductor region 118 is formed on the active layer 116, however, the regions may be reversed. That is, the p-type semiconductor region 118 may be formed on the substrate 102 and the n-type semiconductor region 114 may formed on the active layer 116. As those skilled in the art will readily appreciate, the various concepts described throughout this disclosure may be extended to any suitable layered structure. Additional layers or regions (not shown) may also be included in the LED 101, including but not limited to buffer, nucleation, contact and current spreading layers or regions, as well as light extraction layers.

The p-type semiconductor region 118 is exposed at the top surface, and therefore, the p-type electrode 106 may be readily formed thereon. However, the n-type semiconductor region 114 is buried beneath the p-type semiconductor layer 118 and the active layer 116. Accordingly, to form the n-type electrode 108 on the n-type semiconductor region 114, a cutout area or “mesa” is formed by removing a portion of the active layer 116 and the p-type semiconductor region 118 by means well known in the art to expose the n-type semiconductor layer 114 there beneath. After this portion is removed, the n-type electrode 108 may be formed.

FIG. 1 illustrates one exemplary embodiment of an LED, specifically a lateral LED that may be used in the light emitting circuit. However, several different LED configurations are possible, which provide the same effect as LED 101. For instance, the light emitting circuit may include a flip-chip LED. A flip-chip LED includes features similar to the LED illustrated in FIG. 1. However, the features are flipped over. For instance, electrodes 106 and 108 are positioned beneath p-type semiconductor region 118 and n-type semiconductor region 114 rather than above the p-type semiconductor region 118 and n-type semiconductor region 114 as shown in FIG. 1. By flipping the LED 101, the electrodes can be coupled by electrical traces on a substrate rather than by wire bonds, which would be required for the lateral LED architecture.

Additionally, the LED could be configured as a vertical LED. Vertical LEDs provide certain performance benefits over its lateral and flip-chip counterparts. The vertical LED performance benefits can be desirable in certain light emitting designs. The vertical LED includes a similar composition to the lateral LED. However vertical LEDs are typically formed on a sapphire substrate, which is later removed after a silicon substrate is applied to the opposite side of the vertical LED. Removal of the sapphire substrate exposes a top surface of the n-type semiconductor region. An electrode is formed on the n-type semiconductor regions, while the p-electrode is formed below. Thus, current flows upward, rather than laterally, in the vertical LED. In some aspects of the LED, it is possible to reposition the p-electrode on top of the vertical LED.

In an exemplary embodiment of the LED, the LED may be selected to emit blue light. In other embodiments of the LED, the LED may be selected to emit other wavelengths such as red light. When an LED is selected to emit blue light, a light conversion materials such as phosphor may be placed in close proximity to the LED so that the blue light emitted from the LED is converted into white light by the light conversion material. The light conversion material, in some embodiments of the LED, is dispensed directly on the LED. In such embodiments, the light conversion material may be conformally placed over the LED or dispensed over the LED to form a surface such as curved or domed shaped surface to help spread the converted light. Alternatively, in some embodiments of the LED, the light conversion material may be placed remotely to the LED so that there is some spacing between the LED and the light conversion material.

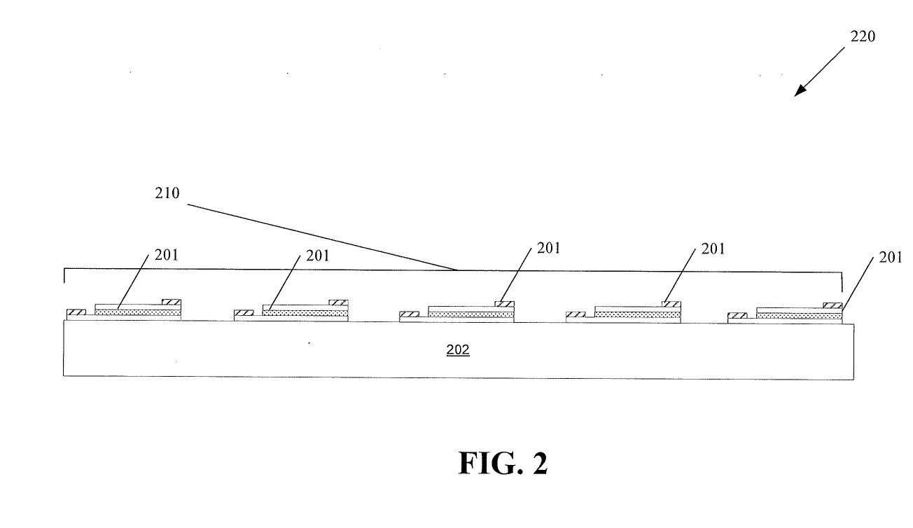

FIG. 2 illustrates a schematic view of solid state light emitters, or in this example, LEDs 201 integrated on a single substrate 202 to form a light emitting circuit 210. The LEDs 201 may be serially coupled by conductive traces (not shown) and require a higher voltage than a conventional single junction LED to drive the circuit. The result is a high voltage light emitting circuit 210 that produces more luminance than a single junction LED without drawing additional current, thereby negating the need for expensive drivers. Additionally, a light conversion material such as phosphor may be placed in close proximity to the LEDs 201 so that light emitted from the LEDs 201 is converted into white light by the light conversion material. The light conversion material can be placed on all of the LEDs 201 as a continuous layer or it can be placed individually on each LED 201 as discrete layers. The light conversion material can be configured to have surfaces or shapes, such as curved or domed shaped surface to help spread the converted light. Alternatively, the light conversion material can be placed remotely to the LED 201 so that there is some spacing between the LED and the light conversion material.

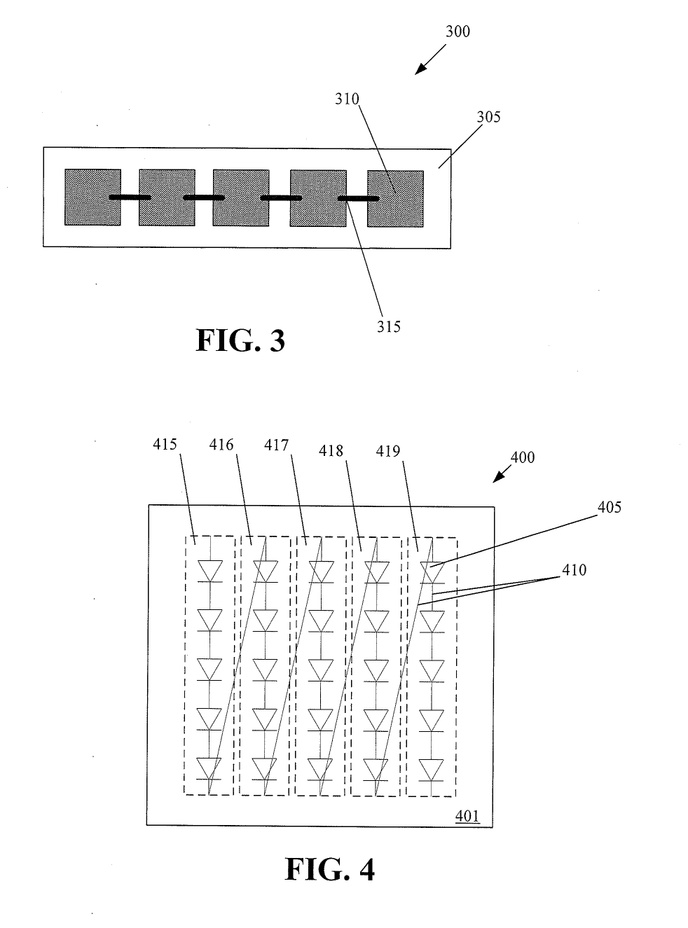

FIG. 3 illustrates an exemplary embodiment of a top view of an integrated circuit 300. In this example, the integrated circuit 300 includes a plurality of light emitting circuits 310 integrated on a single substrate 305. The light emitting circuits 310 may be similar to the circuits described in connection with FIG. 2, or some other suitable circuits. The light emitting circuits 310 may be electrically coupled in series by conductive traces 315. In this example, the integrated circuit is a high voltage solid state light source that can be powered by a low current power source such as rectified AC or DC current. Five serially coupled light emitting circuits 310 are shown, but any number of light emitting circuits may be integrated together on a single substrate. Moreover, the light emitting circuits may be coupled together in any suitable serial and/or parallel arrangement. Those skilled in the art will be readily able to determine the appropriate number of light emitting circuits and the manner in which to couple those circuits together depending on the desired light intensity and the overall design constraints imposed on the apparatus. Additionally, a light conversion material such as phosphor is placed in close proximity to the LEDs so that light emitted from the LEDs is converted into white light by the light conversion material, as discussed with reference to FIGS. 2 and 3.

FIG. 4 illustrates an exemplary embodiment of a schematic view of an integrated circuit 400 having several light emitting circuits 415-419 integrated onto a single substrate 401. Each light emitting circuit 415-419 is shown with several serially coupled solid state light emitters, or in this example, LEDs 405. Conductive traces 410 may be used to couple the light emitting circuits 415-419 together, as well as coupled the LEDs 405 together within each light emitting circuit 415-419.

The LEDs 405 may have any of the configurations discussed above. For instance, LEDs 405 may be lateral LEDs. The conductive traces may be formed on the n electrodes and p electrodes of adjacent dies. Or, in the case where an LED 405 does not have an adjacent opposing contact, the conductive trace 410 may be coupled to the closest opposing electrode that does not have an adjacent opposing contact. For instance, as shown in FIG. 4, the LED illustrated on the bottom of leftmost column is not adjacent to an opposing p-electrode. Furthermore, the LED illustrated in the top of the second column is not adjacent to an opposing n-electrode. Since the bottom left die is one of the closest LEDs with an available n-electrode, a conductive trace couples the two LEDs.

Similar designs may be used for the flip-chip and vertical LEDs. However, in the case of flip-chip LEDs, the conductive traces may be formed completely on the substrate 401 and the flip-chip LEDs are formed above the conductive traces. Vertical LEDs with top electrodes may be electrically coupled in a manner similar to the one described with respect to lateral LEDs.

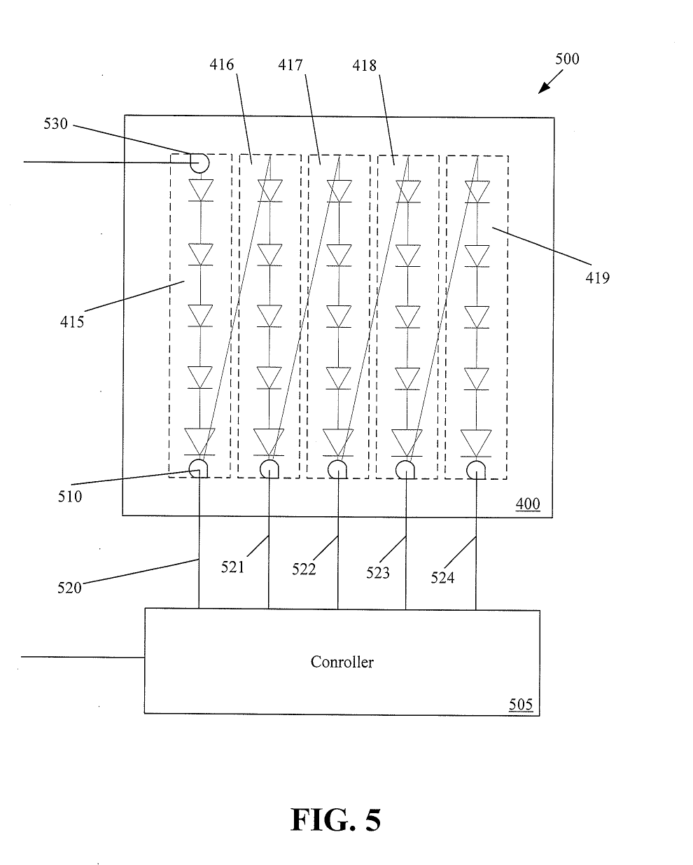

The integrated circuit 400 may be a monolithic chip having a plurality of electrically connected LEDs. The monolithic chip may be fabricated so that all the LEDs are fabricated at the same time and are connected with interconnects that are fabricated on a single wafer. A light conversion materials such as phosphor is placed in close proximity to at least one of the LEDs so that light emitted from the at least one LED is converted into white light by the light conversion material, as discussed with reference to FIGS. 2 and 3. FIG. 5 illustrates an exemplary embodiment of a schematic view of a light emitting apparatus 500 coupled to a controller 505. As shown, the light emitting apparatus 500 may include the integrated circuit 400, discussed in detail with respect to FIG. 4. Additionally, the controller 505 may comprise a control system for providing individual control to the light emitting circuits 415.

The integrated circuit 400 includes several control lines 510 each of which provides independent control to one of the light emitting circuits 415-419. In this example, each control line 510 is attached to the output of a light emitting circuit 415-419. The controller 505 is coupled to the control lines 510 by remote control lines 520-524.

Additionally, the integrated circuit 400 includes an input 530 for coupling to a power source. The controller 505 selectively provides a current path to the power supply return (e.g., ground) for one of the light emitting circuit 415-419 through the remote control line connected to the corresponding control line for the circuit 415-419.

In operation, the voltage applied to the integrated circuit 400 from the power source is monitored by the controller 505. The controller 505 selects a remote control line based on the monitored voltage. By way of example, when the voltage applied to the integrated circuit is at the lowest operational voltage, the first control line 520 may be enabled, thereby providing a current path from the power source through the first light emitting circuit 415 to power supply return (e.g., ground) via the controller 505. As the supplied voltage from the power source is increased to the second lowest operational voltage, the controller 505 may enable the second control line 521, thereby providing a current path from the power source through the first and second light emitting circuit 415, 416 to the power supply return (e.g., ground) via the controller 505. When the supplied voltage from the power source is increased to the next highest operational voltage level, the controller 505 may enable the third control line 522, thereby providing a current path from the power source through the first, second, and third light emitting circuit 415-417 to power supply return (e.g., ground) via the controller 505. In a similar manner, the first, second, third and fourth light emitting circuits 415-418 conduct current at the next highest operational voltage level, with all of the light emitting circuits 415-419 conducting at the highest operation voltage.

For instance, assume that each light emitter has a 3V forward voltage drop and each light emitting circuit has a 15V forward voltage drop. Then, the controller 505 will cause current to flow through the first light emitting circuit 415 when the voltage input to the integrated circuit 400 is at 15V. When the voltage is increased to 30V, the controller 505 will cause current to flow through the first and second light emitting circuits 415, 416. When the voltage is increased to 45V, the controller 505 will cause current to flow through the first, second and third light emitting circuits 415-417. At 60V, current flows through the first, second, third and fourth light emitting circuits 415-418, and at 75V, current flows through all the light emitting circuit 415-419.

Although FIG. 5 illustrates an integrated circuit having 5 light emitting circuits having 5 serially coupled light emitters, any configuration of light emitting circuits may be utilized while still providing the same light output as single junction conventional LEDs. For instance, the integrated circuit may include 3 light emitting circuits of 2 LEDs while still providing sufficient light output. The number of light emitters in a light emitting circuit, as well as the number of light emitting circuits may be tuned as necessary to achieve a requisite brightness and light output.

Additionally, in this example, the number of control lines 520-524 corresponds to the number of light emitting circuits 415-419 on the integrated circuit 400. However, in some aspects of the integrated circuit, the number of control lines could be less or more than then number of light emitting circuits. For instance, the control lines may only be attached to every other light emitting circuit such that the control lines would be configured to power two light emitting circuits at a time. Moreover, the integrated circuit may include more control lines, which provides more granular control of the light output from the light emitting apparatus 500.

FIG. 6 illustrates an exemplary embodiment of a schematic view of a light emitting apparatus. The light emitting apparatus is shown with an integrated circuit 400 having a plurality of light emitting circuits 415-419 and a controller 505 providing individual control of each circuit. The controller 505 is shown with a resistor divider network R1, R2, an analog to digital converter (ADC) 615, a decoder 620, and switches 610-614.

In the exemplary embodiment shown, the voltage applied to the light emitting circuits 415-419 residing on the integrated circuit 400 may be varied remotely depending on the intensity of light desired. The controller 505 monitors the voltage using the resistor divider network R1, R2 or other suitable circuit. The resistor divider network R1, R2 provides a means for monitoring the voltage while providing electrical isolation between the power source (not shown) and the controller 505. In an alternative embodiment, the resistor network R1, R2 may be omitted when electrical isolation is not required.

The output from the resistor divider network R1, R2 may be provided to the ADC 615. The ADC 615 converts the voltage at the output from the resistor network R1, R2 to a digital signal representative of the voltage applied to the light emitting circuits 415-419 residing on the integrated circuit 400.

The digital signal output from the ADC 615 may be provided to the decoder 620. In the described exemplary embodiment, the decoder 620 may be used to select one of several switches 610-614. More specifically, the decoder 620 has multiple output lines with each output line coupled to a different switch. The decoder 620 enables a different one of the output lines for each different digital signal state output from the ADC 615 while disabling the rest of the switches. By way of example, a 15V signal applied to the light emitting circuits 415-419 will drive the ADC output to a “000” state, which in turn will cause the decoder 620 to enable the first switch 610. A 30V signal applied to the light emitting circuits 415-419 will drive the ADC output to a “001” state, which in turn will cause the decoder 620 to enable the second switch 611. A 45V signal applied to the light emitting circuits 415-419 will drive the ADC output to a “010” state, which in turn will cause the decoder 620 to enable the third switch 612. Similarly, a 60V signal applied to the light emitting circuits 415-419 will drive the ADC output to a “011” state, which in turn will cause the decoder 620 to enable the fourth switch 613, and a 75V signal applied to the light emitting circuits 415-419 will drive the ADC output to a “100” state, which in turn will cause the decoder 620 to enable the fifth switch 614.

The switches 610-614 may be field-effect transistors (FET)s or some other suitable switches. Each decoder output is coupled to the gate of a different switch. When the decoder 620 enables a particular switch by applying the appropriate voltage to the gate, the switch is forced into an on position, thereby providing a current sink to the power supply return (e.g., ground) for one of the light emitting circuits 415-419 resident on the integrated circuit 400. By way of example, when a 15V signal applied to the integrated circuit 400, the decoder 620 will drive the gate of the first switch 610 to the appropriate voltage to turn on the device while the rest of the switches remain off. As a result, current will flow from the power source through the first light emitting circuit 415 to the return line through the first switch 610 in the controller 505. When a 30V signal is applied to the integrated circuit 400, the decoder 620 will drive the gate of the first switch 610 to an appropriate voltage to turn off the first switch 610 while driving the gate of the second switch 611 to the appropriate voltage to turn on that device. The rest of the switches will remain off. As a result, current will flow from the power source through the first and second light emitting circuits 415, 416 to the return line through the second switch 611 in the controller 505. When a 45V signal is applied to the integrated circuit 400, the decoder 620 will force the second switch 611 into the off condition while turning on the third switch 612 while the rest of the switches remain off. This will cause current to flow from the power source through the first, second and third light emitting circuits 415-417 to the return line through the third switch 612 in the controller 505. When a 60V signal is applied to the integrated circuit 400, the decoder 620 will turn the third switch 612 off and the fourth switch 613 on while the rest of the switches remain off. This will cause current to flow from the power source through the first, second, third and fourth light emitting circuits 415-418 to the return line through the fourth switch 613 in the controller 505. Finally, when a 75V signal is applied to the integrated circuit 400, the decoder 620 will turn the fourth switch 613 off and the fifth switch 614 on while the rest of the switches remain off. This will cause current will flow from the power source through all the light emitting circuits 415-419 to the return line through the fifth switch 614 in the controller 505.

Conventional wall plugs typically provide 110V of current or 220V of current depending on the country in which the wall plug is located. The light emitting apparatus may be configured to operate from either voltage. The apparatus 600 may be configured for a particular operating voltage through conventional voltage scaling techniques at the input to the integrated circuit 400. Alternatively, the apparatus 600 may be configured for a particular operating voltage by the arrangement of light emitting circuits and the arrangement of light emitters in each circuit. In yet a further exemplary embodiment, the apparatus 600 may be configured to operate off the highest voltage (e.g., 220V), such that when a lower operating voltage is applied (e.g., 110V) no more than half of the light emitting circuits 415-419 will be enabled at one time. Alternatively, by scaling the resistor divider network R1, R2 through an external switch (not shown), the full range of light intensity can be realized for both operating voltages. Those skilled in the art will be readily able to determine the appropriate design for any particular application based on the overall design parameters imposed on the system.

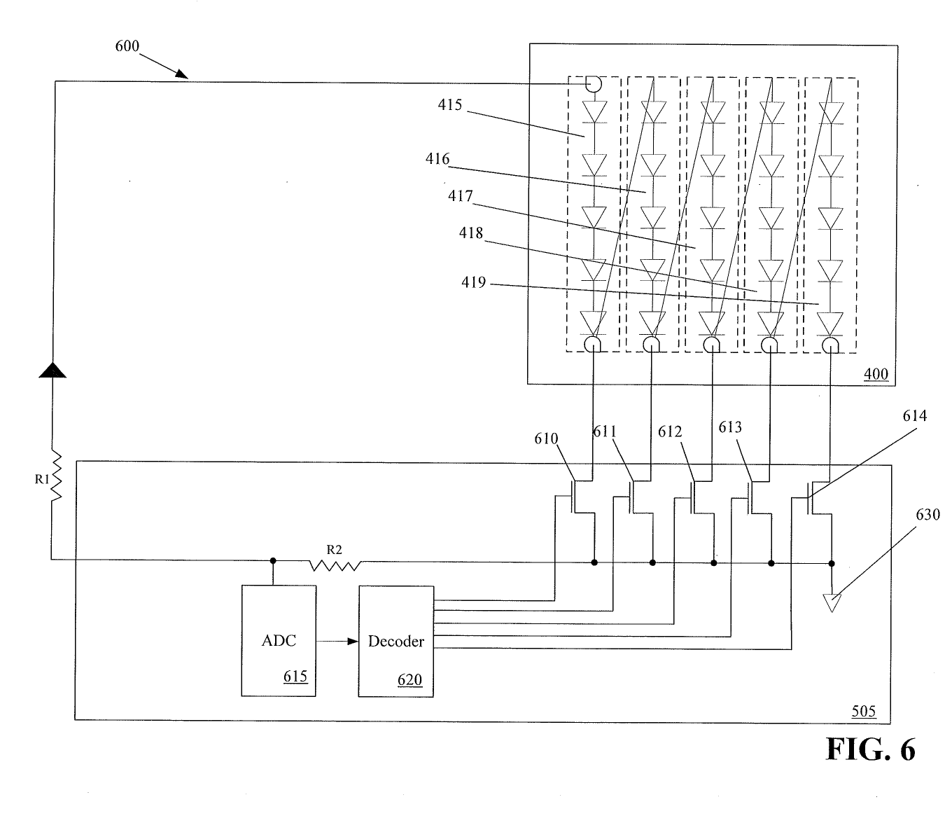

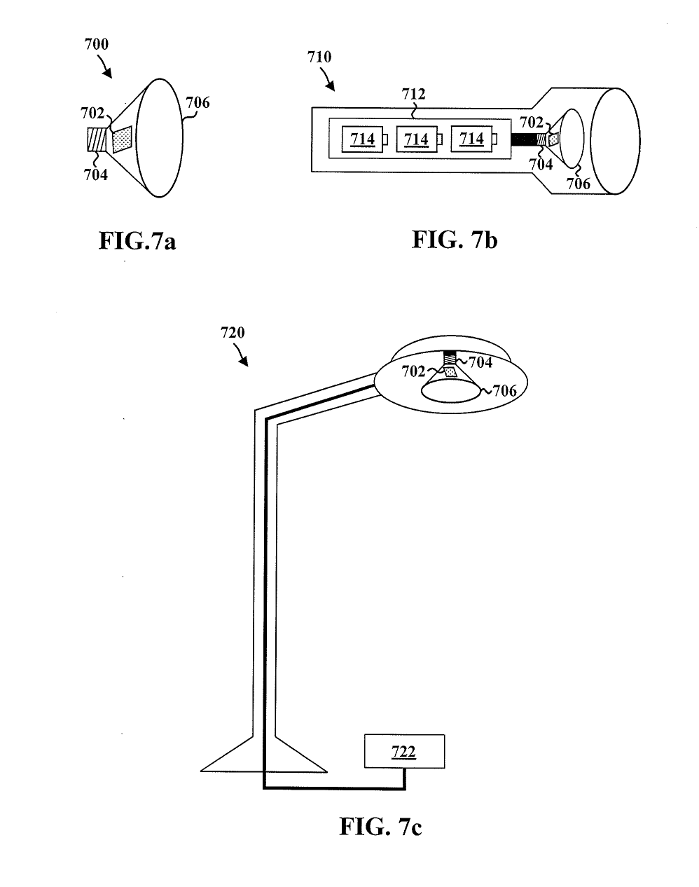

FIG. 7a is a side view illustration of an exemplary lamp 700 having a light emitting apparatus 702. Lamp 700 may be used for any type of general illumination. For example, lamp 700 may be used in an automobile headlamp, street light, overhead light, or in any other general illumination application. The light emitting apparatus 702 may be located in a housing 706. The light emitting apparatus 702 may receive power via a power connection 704. As discussed above, the light emitting apparatus 702 may receive 110V of power or 220V of power and still operate normally. The light emitting apparatus 702 may be configured to emit light. Description pertaining to the process by which light is emitted by the light-emitting circuit 702 is provided with reference to FIG. 6.

FIG. 7b is a side view illustration of a flashlight 710, which is an exemplary embodiment of an apparatus having the light emitting apparatus 702. The light emitting apparatus 702 may be located inside of the housing 706. The flashlight 710 may include a power source. In some aspects of the light emitting apparatus, the power source may include batteries 714 located inside of a battery enclosure 712. In another aspect of the light emitting apparatus, power source 710 may be any other suitable type of power source, such as a solar cell. The power connection 704 may transfer power from the power source (e.g., the batteries 714) to the light-emitting apparatus 702.

FIG. 7c is a side view illustration of a street light 720, which is another exemplary embodiment of an apparatus having the light emitting apparatus 702. The light emitting apparatus 702 may be located inside of the housing 706. The street light 720 may include a power source. In some exemplary embodiments, the power source may include a power generator 722. The power connection 704 may transfer power from the power source (e.g., the power generator 722) to the light emitting apparatus 702.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other circuits. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A light emitting apparatus, comprising:
an integrated circuit comprising:
a plurality of electrically coupled light emitting circuits; and
a plurality of control lines to control the light emitting circuits, each of the control lines configured to provide individual control for a different one of the light emitting circuits from a source remote to the integrated circuit.

2. The light emitting apparatus of claim 1, wherein the plurality of light emitting circuits are electrically coupled in series.

3. The light emitting apparatus of claim 2, further comprising a controller configured to selectively couple a power supply between an input to the series coupled light emitting circuits and the control line to one of the light emitting circuits.

4. The light emitting apparatus of claim 1, wherein each of the light emitting circuits comprises a plurality of solid state light emitters.

5. The light emitting apparatus of claim 4, wherein the solid state light emitters in each of the light emitting circuits are electrically coupled in series.

6. The light emitting apparatus of claim 1, further comprising a controller coupled to the control lines of the integrated circuit to provide said individual control of the light emitting circuits.

7. The light emitting apparatus of claim 6, wherein the controller further comprises a plurality of remote control lines, each of the remote control lines being coupled to a corresponding one of the control lines of the integrated circuit to provide said individual control of the light emitting circuits.

8. The light emitting apparatus of claim 7, wherein the controller is further configured to selectively provide a power supply return path for one of the light emitting circuits through said one of the light emitting circuit's control line via the corresponding remote control line.

9. A light emitting apparatus, comprising:
an integrated circuit comprising:
a plurality of electrically coupled light emitting circuits, each of the light emitting circuits having an output, and
a plurality of control lines, each of the control lines providing a connection from a remote source to the output of a different one of the light emitting circuits.

10. The light emitting apparatus of claim 9, wherein the plurality of light emitting circuits are electrically coupled in series.

11. The light emitting apparatus of claim 10, wherein the remote source is a controller configured to selectively couple a power supply between an input to the series coupled light emitting circuits and the control line to one of the light emitting circuits.

13. The light emitting apparatus of claim 9, wherein each of the light emitting circuits comprises a plurality of solid state light emitters.

14. The light emitting apparatus of claim 13, wherein the solid state light emitters in each of the light emitting circuits are electrically coupled in series.

15. The light emitting apparatus of claim 9, wherein the remote source is a controller coupled to the control lines of the integrated circuit to provide individual control of the light emitting circuits.

16. The light emitting apparatus of claim 15, wherein the controller further comprises a plurality of remote control lines, each of the remote control lines being coupled to a corresponding one of the control lines of the integrated circuit to provide said individual control of the light emitting circuits.

17. A light emitting apparatus, comprising:
an integrated circuit comprising:
a plurality of series coupled light emitting circuits, wherein the series coupling of light emitting circuits comprises an input, and wherein each of the light emitting circuits comprises an output, and
a plurality of control lines, each of the control lines providing a connection from a remote source to a different one of the light emitting circuits; and
a controller configured to control the intensity of light emitted from the integrated circuit by selectively coupling a power source between the input of the series coupled light emitting circuits and one of the outputs of the light emitting circuits.

18. The light emitting apparatus of claim 17, wherein the plurality of light emitting circuits are electrically coupled in series.

19. The light emitting apparatus of claim 17, wherein each of the light emitting circuits comprises a plurality of solid state light emitters.

20. The light emitting apparatus of claim 17, wherein the controller further comprises a plurality of remote control lines, each of the remote control lines being coupled to a corresponding one of the control lines of the integrated circuit to provide individual control of the light emitting circuits.

21. The light emitting apparatus of claim 20, wherein the controller is further configured to selectively provide a power supply return path for one of the light emitting circuits through said one of the light emitting circuit's control line via the corresponding remote control line.
